(19) United States
(12) Patent Application Publication
(10) Pub. No.: US 2005/0107073 A1
(43) Pub. Date: May 19, 2005

(54) Multimedia data streaming in a single threaded mobile communication device operating environment

(76) Inventors: Michael Cheiky, Thousand Oaks, CA (US); Nicolas Antczak, Sherman Oaks, CA (US)

Correspondence Address: MARVIN E. JACOBS, ESQ., 2151 ALESSANDRO DRIVE, SUITE 215, VENTURA, CA, 93001, US

(21) Appl. No.: 10/714,459

(22) Filed: Nov. 13, 2003

(51) Int. Cl. H04M 11/10

(52) U.S. Cl. 455/414.2

(57) ABSTRACT

A mobile communication device includes infrastructure capable of processing streamed multimedia data in a single threaded operating environment. The infrastructure comprises a central processing unit (CPU), an operating system (OS), and a digital signal processor (DSP) operatively coupled to the CPU. A high level application is coupled to the CPU via a memory bus. The high level application is given direct access to the DSP. The high level application instructs the CPU to display a first downloaded image in a slide show format, and hand over audio processing of an associated first downloaded sound clip to the DSP. The CPU is free to immediately download a successive image and a successive associated sound clip, thereby creating the appearance of processing the multimedia data stream in a multithreaded mode.

### FIELD OF THE INVENTION

The present invention relates generally to multimedia data streaming, and more particularly to multimedia data streaming in a single threaded mobile communication device operating environment.

### BACKGROUND OF THE INVENTION

Cellular telephones are rapidly evolving from voice-only mobile telephones into more dynamic portable wireless network-enabled communication devices. Consequently, a broad range of software applications is being developed to enable access and display of a variety of multimedia information on these devices. However, the limited memory, storage, and processor power of these devices places constraints on the type of data (audio, video, images, text) that can be streamed to the user. Video streaming, for example, is practically on every cellular telephone user's wish list.

In general, data streaming is a method of making audio, video and other multimedia available to the user in near real-time over a network. Through data streaming, the user does not have to wait to download the entire multimedia file and then play it. Rather, the user can view and/or hear the multimedia content of a requested multimedia file after only a relatively short delay. The data in the file is broken into small packets that are sent over the network in a continuous flow (stream) to the end-user's mobile telephone. It is thus possible for the user to begin viewing the multimedia file from the beginning as the rest of the packets are being transferred to the end-user's mobile telephone while playing. A short delay is normally introduced at the start to allow a small amount of data to be buffered. The data buffer enables playback to continue uninterrupted despite variations in the rate of received data. Yet, high-level multimedia applications running on many of these devices are single-threaded, and, therefore, unable to run streaming multimedia applications that require multiple threads to download data, display graphics and decompress audio and/or video simultaneously.

In general, multithreading is a programming technique that enables an application to handle more than one operation at the same time. Threads are commonly employed for timely events, when a job must be scheduled to take place at a specific time or at specific intervals, and for background processing, when background events must be handled or executed in parallel to the current flow of execution. Examples of timely events include program reminders, timeout events, and repeated operations such as polling (monitoring) of certain system components, as well as refreshes. In a single threaded operating environment, a program executes itself in one location and one instruction at a time.

The audio codecs that are used on handheld wireless network-enabled devices are not normally accessible to the high level multimedia applications that run on top of the underlying operating system (OS) that controls the handheld wireless device functionality. Such applications are normally kept isolated from the OS to avoid causing system crashes and interruption of critical handheld wireless device processes.

### SUMMARY OF THE INVENTION

In accordance with one aspect of the present invention, a mobile communication device comprises infrastructure capable of processing streamed multimedia data in a single threaded operating environment. The single threaded operating environment is adapted to process the streamed multimedia data in a virtual multithreaded mode using a slide show format.

In accordance with another aspect of the present invention, a method for processing streamed multimedia data comprises the steps of utilizing at least one central processing unit (CPU) to download an image and an associated sound clip, the downloaded image and sound clip being part of a multimedia data stream; utilizing the CPU to display the downloaded image in a slide show format; handing over audio processing of the downloaded sound clip to at least one digital signal processor (DSP) to free up the CPU to download a successive image and a successive associated sound clip; monitoring the DSP to determine if audio processing of the downloaded sound clip is complete; and repeating the previous three steps, if audio processing of the downloaded sound clip is complete, to create the appearance of processing the multimedia data stream in a multithreaded mode.

In accordance with yet another aspect of the present invention, a method for processing streamed multimedia data comprises the steps of utilizing at least one central processing unit (CPU) to download an image and an associated sound clip, the downloaded image and sound clip being part of a multimedia data stream; utilizing the CPU to display the downloaded image in a slide show format, with the CPU having a CPU clock; handing over audio processing of the downloaded sound clip to at least one digital signal processor (DSP) to free up the CPU to download a successive image and a successive associated sound clip; monitoring the CPU clock to determine when to instruct the CPU to display the downloaded successive image; and repeating the previous three steps to create the appearance of processing the multimedia data stream in a multithreaded mode.

In accordance with still another aspect of the present invention, an apparatus for processing streamed multimedia data comprises at least one central processing unit (CPU) being used to download images and associated sound clips, the downloaded images and associated sound clips being part of a multimedia data stream, with the CPU being utilized to display the downloaded images; at least one operating system (OS) operatively coupled to the CPU; at least one digital signal processor (DSP) operatively coupled to the CPU and adapted for audio processing of the associated downloaded sound clips; and at least one high level application operatively coupled to the CPU and adapted to directly access the DSP and run under the auspices of the OS. The high level application is adapted to instruct the CPU to display a first downloaded image in a slide show format, hand over audio processing of a first associated downloaded sound clip to the DSP, immediately download a successive image and associated successive sound clip, monitor the DSP to determine if audio processing of the first downloaded sound clip is complete, and display the downloaded successive image, if audio processing of the first downloaded sound clip is complete, to create the appearance of processing the multimedia data stream in a multithreaded mode.

In accordance with a different aspect of the present invention, an apparatus for processing streamed multimedia data comprises at least one central processing unit (CPU) being used to download images and associated sound clips, the downloaded images and associated sound clips being part of a multimedia data stream, with the CPU being utilized to display the downloaded images; at least one operating system (OS) operatively coupled to the CPU; at least one digital signal processor (DSP) operatively coupled to the CPU and adapted for audio processing of the associated downloaded sound clips; and at least one high level application operatively coupled to the CPU and adapted to directly access the DSP and run parallel to the OS. The high level application is adapted to instruct the CPU to display a first downloaded image in a slide show format, hand over audio processing of a first associated downloaded sound clip to the DSP, immediately download a successive image and associated successive sound clip, monitor the DSP to determine if audio processing of the first downloaded sound clip is complete, and display the downloaded successive image, if audio processing of the first downloaded sound clip is complete, to create the appearance of processing the multimedia data stream in a multithreaded mode.

In accordance with a still different aspect of the present invention, an apparatus for processing streamed multimedia data comprises at least one central processing unit (CPU) being used to download images and associated sound clips, the downloaded images and associated sound clips being part of a multimedia data stream, with the CPU being utilized to display the downloaded images; at least one operating system (OS) operatively coupled to the CPU, with the CPU having a CPU clock; at least one digital signal processor (DSP) operatively coupled to the CPU and adapted for audio processing of the associated downloaded sound clips; and at least one high level application operatively coupled to the CPU and adapted to directly access the DSP and run under the auspices of the OS. The high level application is adapted to instruct the CPU to display a first downloaded image in a slide show format, hand over audio processing of a first associated downloaded sound clip to the DSP, immediately download a successive image and associated successive sound clip, monitor the CPU clock to determine when to instruct the CPU to display the downloaded successive, and display the downloaded successive image to create the appearance of processing the multimedia data stream in a multithreaded mode.

In accordance with another different aspect of the present invention, an apparatus for processing streamed multimedia data comprises at least one central processing unit (CPU) being used to download images and associated sound clips, the downloaded images and associated sound clips being part of a multimedia data stream, with the CPU being utilized to display the downloaded images; at least one operating system (OS) operatively coupled to the CPU, with the CPU having a CPU clock; at least one digital signal processor (DSP) operatively coupled to the CPU and adapted for audio processing of the associated downloaded sound clips; and at least one high level application operatively coupled to the CPU and adapted to directly access the DSP and run parallel to the OS. The high level application is adapted to instruct the CPU to display a first downloaded image in a slide show format, hand over audio processing of a first associated downloaded sound clip to the DSP, immediately download a successive image and associated successive sound clip, monitor the CPU clock to determine when to instruct the CPU to display the downloaded successive, and display the downloaded successive image to create the appearance of processing the multimedia data stream in a multithreaded mode.

In accordance with still another different aspect of the present invention, a system for processing streamed multimedia data comprises at least one high level application operatively coupled between at least one central processing unit (CPU) and at least one digital signal processor (DSP) and adapted to run under the auspices of at least one operating system (OS). The high level application is adapted to instruct the CPU, by way of the OS, to display a downloaded image, hand over audio processing of an associated downloaded sound clip to the DSP, and immediately download a successive image and associated successive sound clip to create the appearance of processing the streamed multimedia data in a multithreaded mode.

In accordance with yet another different aspect of the present invention, a system for processing streamed multimedia data comprises at least one high level application operatively coupled between at least one central processing unit (CPU) and at least one digital signal processor (DSP) and adapted to run parallel to at least one operating system (OS). The high level application is adapted to instruct the CPU, bypassing the OS, to display a downloaded image, hand over audio processing of an associated downloaded sound clip to the DSP, and immediately download a successive image and associated successive sound clip to create the appearance of processing the streamed multimedia data in a multithreaded mode.

These and other aspects of the present invention will become apparent from a review of the accompanying drawings and the following detailed description of the present invention.

### BRIEF DESCRIPTION OF THE DRAWINGS

The present invention is generally shown by way of reference to the accompanying drawings in which:

FIG. 1 is a schematic representation of a mobile communication device adapted to present streamed multimedia data in slide show format with accompanying audio in accordance with the present invention;

FIG. 2 is a block diagram of a representative infrastructure of the mobile communication device of FIG. 1 in accordance with the present invention;

FIG. 3 is a flow chart of a multimedia slide show streaming process in accordance with one embodiment of the present invention;

FIG. 4 is a flow chart of a multimedia slide show streaming process in accordance with another embodiment of the present invention;

FIG. 5 is a block diagram of one exemplary implementation of the mobile communication device infrastructure of FIG. 2 in accordance with the present invention;

FIG. 6 is a block diagram of another exemplary implementation of the mobile communication device infrastructure of FIG. 2 in accordance with the present invention;

FIG. 7 is a block diagram of yet another exemplary implementation of the mobile communication device infrastructure of FIG. 2 in accordance with the present invention; and

FIG. 8 is a block diagram of still another exemplary implementation of the mobile communication device infrastructure of FIG. 2 in accordance with the present invention.

### DETAILED DESCRIPTION OF THE INVENTION

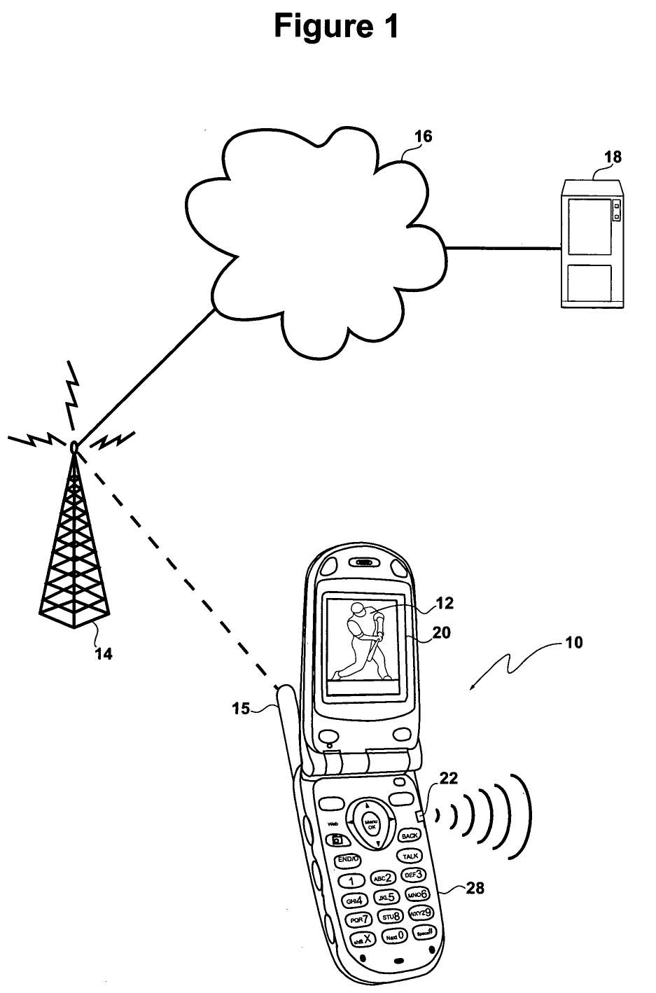

Some preferred embodiments of the present invention will be described in detail with reference to the related drawings of FIGS. 1-8. Additional embodiments, features and/or advantages of the invention will become apparent from the ensuing description or may be learned by practicing the invention.

In the figures, the drawings are not to scale with like numerals referring to like features throughout both the drawings and the description.

The following description includes the best mode presently contemplated for carrying out the invention. This description is not to be taken in a limiting sense, but is made merely for the purpose of describing the general principles of the invention.

FIG. 1 schematically illustrates a handheld wireless communication device, such as a mobile telephone 10, receiving a multimedia data stream from a server 18 by way of a wireless network 16 and a wireless communication tower 14. Mobile telephone 10 is a low-end network-enabled handheld wireless telephone, i.e. having limited memory, storage and processor power. Wireless network 16 is of the low-bandwidth wireless-handheld network type. Mobile telephone 10 is equipped with an antenna 15 for establishing communication with wireless tower 14, a display 20, a user input interface, such as a keypad 28, and a handset speaker 22.

Mobile telephone 10 is adapted to process the multimedia data stream and present the processed data stream to the user in a slide show format 12 with accompanying audio by way of display 20 and handset speaker 22, respectively, as generally depicted in FIG. 1. This type of presentation enables the user to view and hear rather than just view multimedia content being streamed on-demand by server 18. Server 18 may contain customized multimedia content with the user being able to select a particular slide show presentation via keyboard 22 of mobile telephone 10.

Multimedia content including graphics, text and sound clips may be transmitted over wireless network 16 between server 18 and mobile telephone 10 in a variety of ways. For example, server 18 and mobile telephone 10 may be adapted to use Multimedia Message Service (MMS) which is a store-and-forward method of transmitting graphics, sound files, image files and short text messages over wireless networks using WAP (Wireless Application Protocol). WAP is a secure specification allowing users to access information instantly via handheld wireless devices such as mobile telephones, pagers, two-way radios, smart phones and communicators. WAP supports most wireless networks including Code Division Multiple Access (CDMA), Time Division Multiple Access (TDMA), Global System for Mobile Communications (GSM), Personal Handyphone System (PHS), Integrated Digital Enhanced Network (iDEN), etc. WAP is supported by most operating systems specifically designed for use on handheld devices including PalmOS™, EPOC™, Windows CE™, FLEXOS™, OS/9™, and JavaOS™. WAPs that use displays and access the Internet run micro browsers, i.e. browsers with small file sizes that can accommodate the low memory constraints of mobile handheld devices, such as mobile telephone 10 (FIG. 1), and the low-bandwidth constraints of wireless-handheld networks, such as wireless network 16 (FIG. 1). Other methods of transmitting multimedia content over wireless networks may be employed, provided such other methods do not deviate from the intended purpose of the present invention.

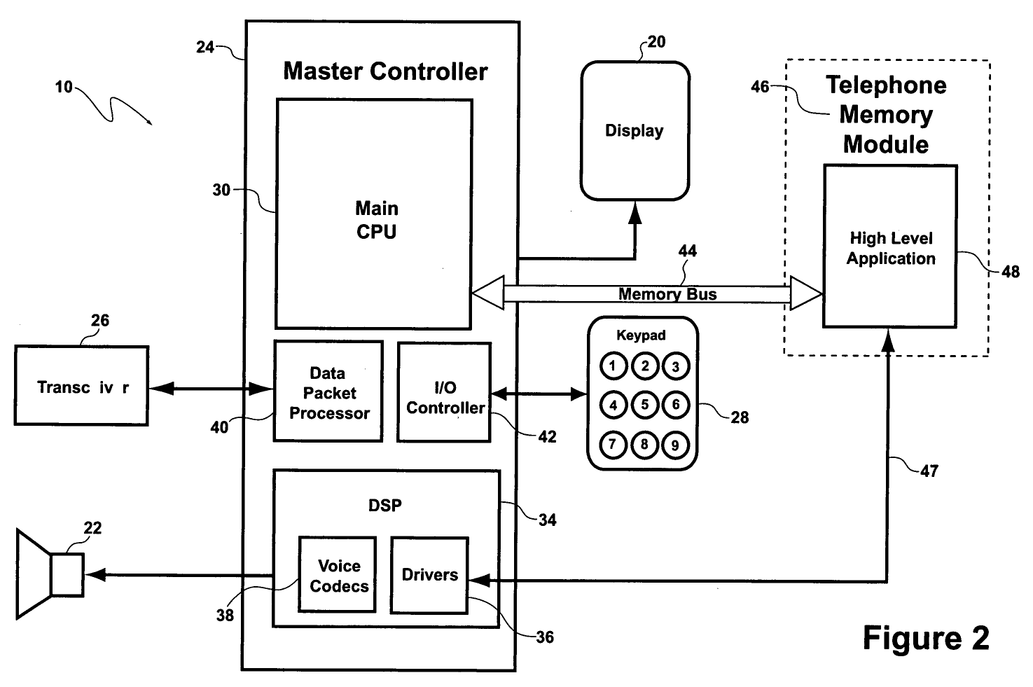

The infrastructure of mobile telephone 10 comprises a master controller 24 including a main CPU (central processing unit) 30, which is operatively coupled to a high level application 48 via a memory bus 44, as schematically depicted in FIG. 2. High level application 48 resides in a telephone memory module (TMM) 46. In one implementation, main CPU 30 may be a low-power Intel® StrongArm® processor which is available commercially from vendors nationwide. Other processor implementations may be possible, provided such other implementations stay within the intended scope of the present invention.

Master controller 24 also comprises an I/O (input/output) controller 42, a data packet processor (DPP) 40, and a digital signal processor (DSP) 34. One function of I/O controller 42 (FIG. 2) is to control input from keypad 28 (FIG. 1). DPP 40 processes data packets received from a transceiver 26 (FIG. 2). Transceiver 26 is adapted to allow reception of data packets via antenna 15 (FIG. 1) during transmission periods, i.e. it operates in full duplex mode.

Data packet is a standard format in which digital data is transmitted over a network. Each packet contains the data itself, which may be in compressed form, as well as addresses, error checking, and other information necessary to ensure that the packet arrives intact at its intended destination. In one example, a data packet may include a header, a voice code, a trailer, and error correcting code (ECC). In another example, a data packet may include a header to open communication, general data, and a trailer to inform the receiving unit that data transmission is complete and that the receiving unit should stand by for the next data packet. The function of DPP 40 is to error check the received data packets, to remove the headers and trailers, to assemble the downloaded data into files, and to hand over the files to main CPU 30 for handling by the mobile telephone operating system (OS) and high level application 48.

Data compression is used to minimize the amount of storage space required as well as the time required to download various large size files. Data compression involves eliminating redundancies in data, and may be performed on any kind of file, including text, images, audio, etc. Once downloaded, the file may be restored to its original size via a suitable decompression algorithm.

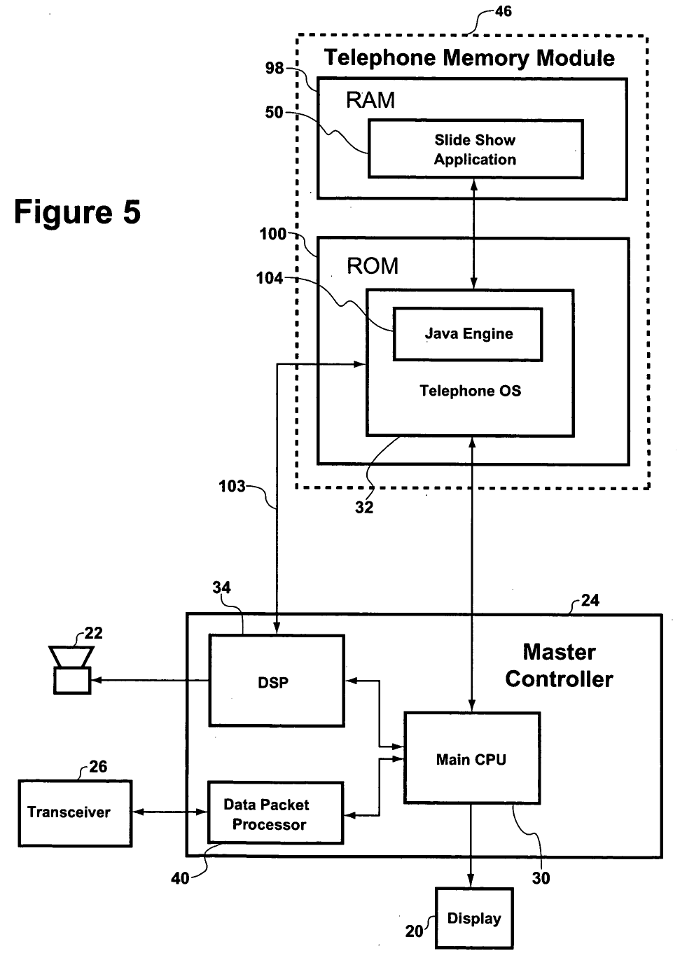

In case of compressed audio data, the decompression algorithm may be handled by a dedicated codec (compression/decompression) chip, by a separate digital signal processor (DSP), or by code in a mobile telephone master control unit (MCU), such as by voice codecs 38 in DSP 34 of master controller 24, as schematically shown in FIG. 2. For example, if mobile telephone 10 is implemented as a CDMA telephone, it may use QCELP (QualComm Code Excited Linear Predictive Coding) voice data compression. QCELP is a vector quantizer-based speech codec that changes compression ratios for segments of speech and supports adaptive rates such as 4 kbps (kilobits per second), 8 kbps, and 12 kbps voice. Decompressed voice is output in analog form to handset speaker 22 (FIG. 2). Compressed image data may be decompressed by appropriate code in master controller 24. The decompressed image data is processed and sent by main CPU 30 to display 20, as generally depicted in FIGS. 5-8, for viewing by the user.

In accordance with a preferred embodiment of the present invention, high level application 48 utilizes main CPU 30 and DSP 34 to emulate running a multimedia slide show stream in a multithreaded mode, while actually running the same in a single thread mode due to inherent processor, memory and storage limitations of mobile telephone 10 as well as low-bandwidth constraints imposed by wireless-handheld network 16 (FIG. 1). Specifically, high level application 48 is given access to low level DSP drivers 36 (FIG. 2) to allow high level application 48 direct control of DSP 34 and its voice codecs 38, as generally shown by bi-directional arrow 47 of FIG. 2. A person skilled in the art should appreciate that such access is unprecedented in prior wireless mobile telephone setups due to the necessity of keeping the mobile telephone OS isolated by a firewall, i.e. to prevent possible crashing of the telephone OS which would render the mobile telephone useless. This type of setup frees up main CPU 30 to immediately continue downloading successive data (images, and audio), after displaying the current static image, with the audio processing and output of the associated current sound clip being transferred to DSP 34, so as to create the appearance of multithreading.

High level application 48 may be implemented under the Java™ 2 Platform, Micro Edition (J2ME) which is engineered for use on consumer and embedded devices such as mobile telephones, PDAs, TV set-top boxes, in-vehicle telematics systems, etc. The J2ME platform includes generally a flexible user interface, robust security model, broad range of built-in network protocols, and support for high level networked applications. Actual J2ME configurations are composed of a virtual machine (Java engine) and a minimal set of class libraries that provide the base functionality for particular range of devices that share similar characteristics, such as network connectivity and memory footprint. One J2ME configuration suitable for use with mobile telephone 10, in accordance with the general principles of the present invention, is the Connected Limited Device Configuration (CLDC). CLDC is specifically designed for devices with intermittent network connections, slow processors and limited memory such as mobile telephones, two-way pagers and PDAs.

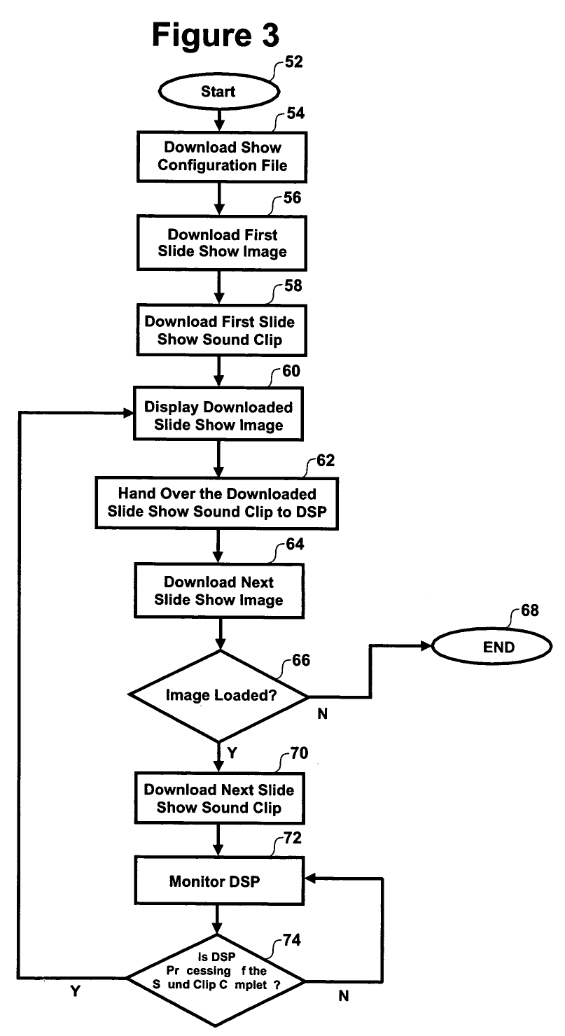

In one embodiment of the present invention, high level application 48 may be implemented by means of a Java engine 104 which runs under the auspices of a telephone OS 32 of mobile telephone 10 (FIGS. 1-2), as generally shown in FIG. 5. Java engine 104 runs a slide show application 50 and is given access to low level DSP drivers 36 (FIG. 2) to allow Java engine 104 control of DSP 34 (FIG. 5) and its voice codecs 38 (FIG. 2) by way of telephone OS 32 (FIG. 5), as generally shown by bi-directional arrow 103 of FIG. 5. Java engine 104 and telephone OS 32 reside in read only memory (ROM) 100 (FIG. 5) of TMM 46 (FIGS. 2, 5) of mobile telephone 10 (FIGS. 1-2). Slide show application 50 resides in random access memory (RAM) 98 (FIG. 5) of TMM 46 (FIGS. 2, 5) of mobile telephone 10 (FIGS. 1-2) and, as generally illustrated in FIG. 3, may be implemented using the following functional steps:
(1) The slide show program is executed on network-enabled mobile telephone 10 (FIG. 1), “start” step 52.
(2) Main CPU 30 downloads a show configuration file, step 54, on instructions from Java engine 104. The show configuration file contains information on how long each slide show image would be displayed, and on the duration of each associated slide show sound clip.
(3) Main CPU 30 downloads the first slide show image, step 56, on instructions from Java engine 104.
(4) Main CPU 30 downloads the first slide show sound clip, step 58, on instructions from Java engine 104.
(5) Main CPU 30 promptly sends the first downloaded slide show image to display 20 (FIG. 5), step 60, on instructions from Java engine 104. The displayed image is a static image, as generally shown, for example, in FIG. 1.
(6) Upon appropriate instructions from Java engine 104, main CPU 30 hands over the first downloaded slide show sound clip to DSP 34, step 62, with DSP 34 outputting the same in analog form to speaker 22, as schematically depicted in FIG. 5. The user views the displayed static image while listening to the speaker output.
(7) As soon as main CPU 30 has handed over the first downloaded slide show sound clip to DSP 34, main CPU 30 downloads the next slide show image, step 64, on instructions from Java engine 104. Main CPU 30 is free to immediately download the next slide show image since audio processing of the first downloaded slide show sound clip has been transferred to DSP 34, thereby creating the appearance of multithreading. This “virtual” multithreading mode is made possible by Java engine 104 being able to directly control DSP 34 and its voice codecs 38 (FIG. 2) by way of telephone OS 32, as generally shown by bi-directional arrow 103 of FIG. 5.
(8) Java engine 104 checks with main CPU 30 by way of telephone OS 32 whether downloading of the slide show image (of step 64) is complete, step 66.
(9) If image downloading fails for any reason, such as due to network error or no more images being available for download, Java engine 104 terminates the slide show, “end” step 68.
(10) If image downloading is complete, main CPU 30 downloads the next slide show sound clip, step 70, on instructions from Java engine 104.
(11) Java engine 104 is preferably programmed to monitor DSP 34 by way of telephone OS 32, step 72, as generally shown in FIG. 5, to determine if audio output of the first downloaded slide show sound clip by DSP 34 is complete, step 74. One way to program Java engine 104 to monitor DSP 34 may involve adding a listener using a statement such as Player.addPlayerListener(PlayerListenerlistener), where Player is the object and addPlayerListener is the method that belongs to class Player. The listener is a Java entity that listens for various events in the system. In this case, the listener listens for events that happen to the Player object. When DSP 34 completes audio output of the first downloaded slide show sound clip, the listener invokes user-implemented callback method playerUpdate (int event, java.lang.Object eventData), where event is stopped when a Player has stopped. Other programming methods may be utilized, provided such other methods do not depart from the intended purpose of the present invention.
(12) If audio output of the first downloaded slide show sound clip is not complete, Java engine 104 continues to monitor DSP 34, step 72, until audio output is complete.
(13) If audio output of the first downloaded slide show sound clip is complete, main CPU 30 promptly sends the slide show image downloaded, in reference to steps 64-66 (FIG. 3), to display 20 (FIG. 5), with steps 60-74 being repeated until the last slide show image and sound clip are downloaded and processed in the manner generally illustrated in FIG. 3.

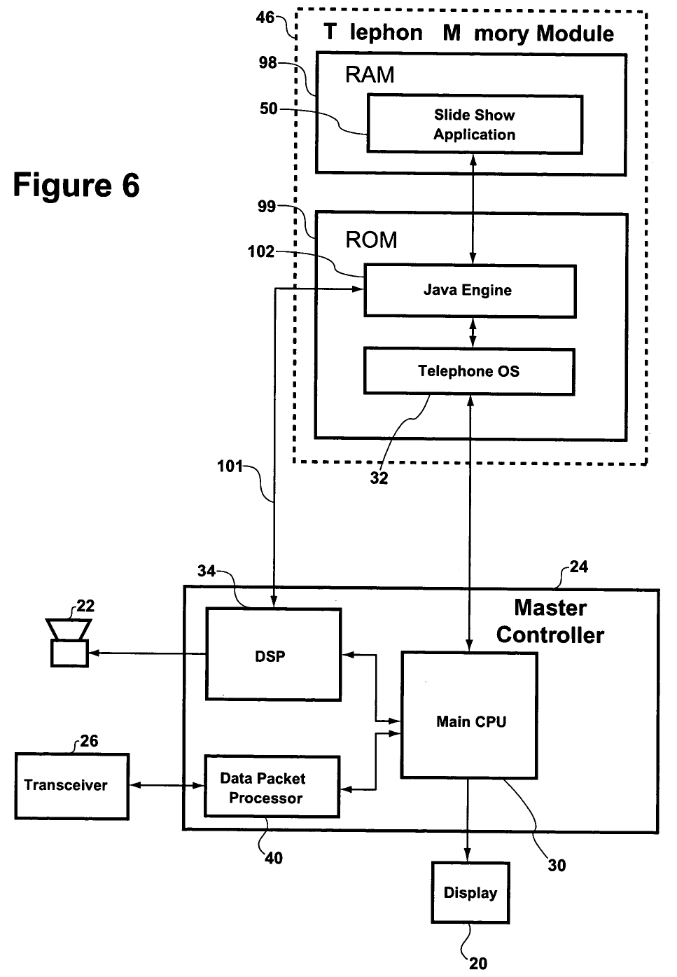

In another embodiment of the present invention, high level application 48 may be implemented by means of a Java engine 102 adapted to run parallel to telephone OS 32, as generally depicted in FIG. 6. Java engine 102 runs slide show application 50 and is given access to low level DSP drivers 36 (FIG. 2) to allow Java engine 102 direct control of DSP 34 and its voice codecs 38 (FIG. 2), bypassing telephone OS 32, as generally shown by bi-directional arrow 101 of FIG. 6. Java engine 102 and telephone OS 32 reside in ROM 99 (FIG. 6) of TMM 46 (FIGS. 2, 6). Slide show application 50 resides in RAM 98 (FIG. 6) of TMM 46 (FIGS. 2, 6) and, as generally illustrated in FIG. 3, may be implemented using the following functional steps:
(1) The slide show program is executed on network-enabled mobile telephone 10 (FIG. 1), “start” step 52.
(2) Main CPU 30 downloads a show configuration file, step 54, on instructions from Java engine 102. The show configuration file contains information on how long each slide show image would be displayed, and on the duration of each associated slide show sound clip.
(3) Main CPU 30 downloads the first slide show image, step 56, on instructions from Java engine 102.
(4) Main CPU 30 downloads the first slide show sound clip, step 58, on instructions from Java engine 102.
(5) Main CPU 30 promptly sends the first downloaded slide show image to display 20 (FIG. 6), step 60, on instructions from Java engine 102. The displayed image is static.
(6) Upon appropriate instructions from Java engine 102, main CPU 30 hands over the first downloaded slide show sound clip to DSP 34, step 62, with DSP 34 outputting the same in analog form to speaker 22, as schematically depicted in FIG. 6. The user views the displayed static image while listening to the speaker output.
(7) As soon as main CPU 30 has handed over the first downloaded slide show sound clip to DSP 34, main CPU 30 downloads the next slide show image, step 64, on instructions from Java engine 102. Main CPU 30 is free to immediately download the next slide show image since audio processing of the first downloaded slide show sound clip has been transferred to DSP 34, thereby creating the appearance of multithreading. This “virtual” multithreading mode is made possible by Java engine 102 being able to directly control DSP 34 and its voice codecs 38 (FIG. 2), as generally shown by bi-directional arrow 101 of FIG. 6.
(8) Java engine 102 checks with main CPU 30 whether downloading of the slide show image (of step 64) is complete, step 66.
(9) If image downloading fails for any reason, such as due to network error or no more images being available for download, Java engine 102 terminates the slide show, “end” step 68.
(10) If image downloading is complete, main CPU 30 downloads the next slide show sound clip, step 70, on instructions from Java engine 102.
(11) Java engine 102 is preferably programmed to monitor DSP 34, step 72, as generally shown in FIG. 6, to determine if audio output of the first downloaded slide show sound clip by DSP 34 is complete, step 74. One way to program Java engine 102 to monitor DSP 34 may involve adding a listener using a statement such as
Player.addPlayerListener(PlayerListenerlistener), where Player is the object and addPlayerListener is the method that belongs to class Player. The listener is a Java entity that listens for various events in the system. In this case, the listener listens for events that happen to the Player object. When DSP 34 completes audio output of the first downloaded slide show sound clip, the listener invokes user-implemented callback method playerUpdate(int event, java.lang.Object eventData), where event is stopped when a Player has stopped. Other programming methods may be utilized, provided such other methods do not depart from the intended purpose of the present invention.
(12) If audio output of the first downloaded slide show sound clip is not complete, Java engine 102 continues to monitor DSP 34, step 72, until audio output is complete.
(13) If audio output of the first downloaded slide show sound clip is complete, main CPU 30 promptly sends the slide show image downloaded, in reference to steps 64-66 (FIG. 3), to display 20 (FIG. 6), with steps 60-74 being repeated until the last slide show image and sound clip are downloaded and processed in the manner generally illustrated in FIG. 3.

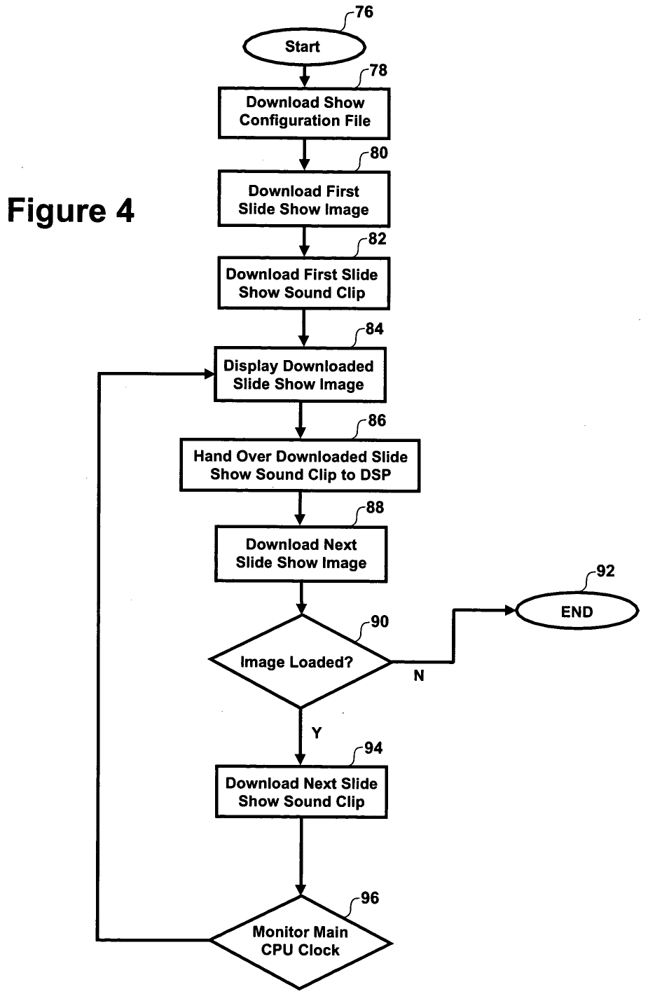

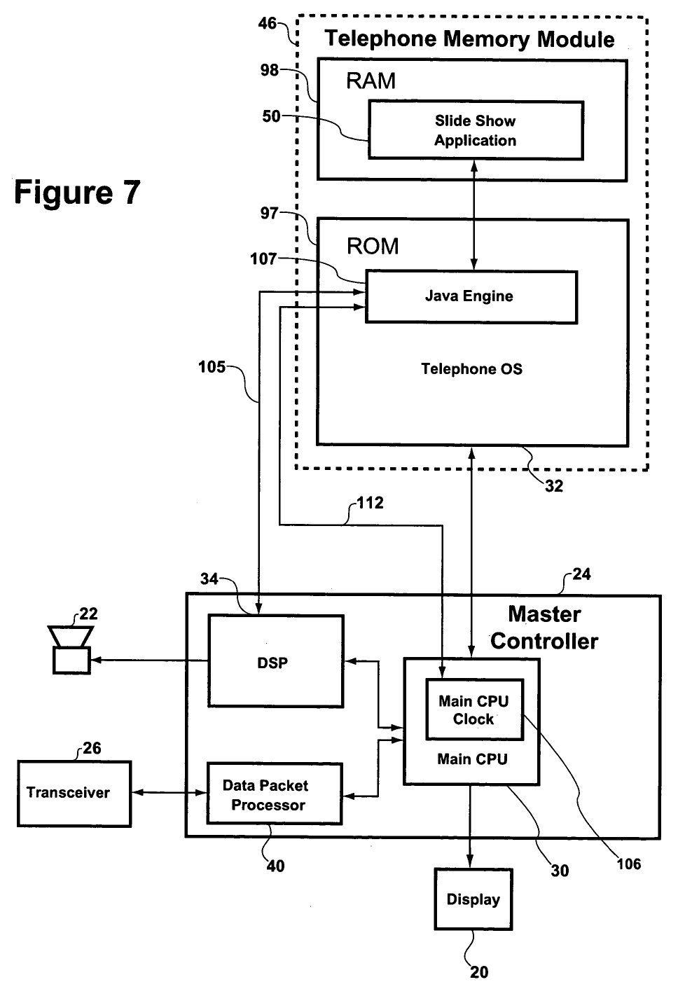

In yet another embodiment of the present invention, high level application 48 may be implemented by means of a Java engine 107 which runs under the auspices of telephone OS 32 of mobile telephone 10 (FIGS. 1-2), as generally shown in FIG. 7. Java engine 107 runs slide show application 50 and is given access to low level DSP drivers 36 (FIG. 2) to allow Java engine 107 control of DSP 34 and its voice codecs 38 (FIG. 2) by way of telephone OS 32, as generally shown by bi-directional arrow 105 of FIG. 7. Java engine 107 and telephone OS 32 reside in ROM 97 (FIG. 7) of TMM 46 (FIGS. 2, 7) of mobile telephone 10 (FIGS. 1-2). Slide show application 50 resides in RAM 98 (FIG. 7) of TMM 46 (FIGS. 2, 7) and, as generally illustrated in FIG. 4, may be implemented using the following functional steps:
(1) The slide show program is executed on network-enabled mobile telephone 10 (FIG. 1), “start” step 76.
(2) Main CPU 30 downloads a show configuration file, step 78, on instructions from Java engine 107. The show configuration file contains information on how long each slide show image would be displayed, and on the duration of each associated slide show sound clip.
(3) Main CPU 30 downloads the first slide show image, step 80, on instructions from Java engine 107.
(4) Main CPU 30 downloads the first slide show sound clip, step 82, on instructions from Java engine 107.
(5) Main CPU 30 promptly sends the first downloaded slide show image to display 20 (FIG. 7), step 84, on instructions from Java engine 107. The displayed image is a static image.
(6) Upon appropriate instructions from Java engine 107, main CPU 30 hands over the first downloaded slide show sound clip to DSP 34, step 86, with DSP 34 outputting the same in analog form to speaker 22, as schematically depicted in FIG. 7. The user views the displayed static image while listening to the speaker output.
(7) As soon as main CPU 30 has handed over the first downloaded slide show sound clip to DSP 34, main CPU 30 downloads the next slide show image, step 88, on instructions from Java engine 107. Main CPU 30 is free to immediately download the next slide show image since audio processing of the first downloaded slide show sound clip has been transferred to DSP 34, thereby creating the appearance of multithreading. This “virtual” multithreading mode is made possible by Java engine 107 being able to directly control DSP 34 and its voice codecs 38 (FIG. 2) by way of telephone OS 32, as generally shown by bi-directional arrow 105 of FIG. 7.
(8) Java engine 107 checks with main CPU 30, by way of telephone OS 32, whether downloading of the slide show image (of step 88) is complete, step 90.
(9) If image downloading fails for any reason, such as due to network error or no more images being available for download, Java engine 107 terminates the slide show, “end” step 92.
(10) If image downloading is complete, main CPU 30 downloads the next slide show sound clip, step 94, on instructions from Java engine 107.
(11) Java engine 107 is preferably programmed to monitor a main CPU clock 106 by way of telephone OS 32, step 96, as generally shown by bi-directional arrow 112 of FIG. 7, to determine when to instruct main CPU 30 to send a successive downloaded slide show image, such as the slide show image downloaded in reference to steps 88-90 (FIG. 4), to display 20 (FIG. 7). The objective is to synchronize the sequential display of downloaded static slide show images with corresponding audio output of their associated downloaded slide show sound clips via speaker 22 (FIG. 7). One way to program Java engine 107 to monitor main CPU clock 106 may involve using a method such as currentTimeMillis, which returns the number of milliseconds that passed since midnight, Jan. 1, 1970. As the current static slide show image is displayed with the accompanying slide show sound clip being output via speaker 22 (FIG. 7), the time just before main CPU 30 starts downloading the next slide show image may be determined from main CPU clock 106 by using the following command:
timeStart=System.currentTimeMillis( )
   Next, the time right after main CPU 30 has completed downloading the next slide show sound clip may be determined from main CPU clock 106 by using the following command:
timeEnd=System.currentTimeMillis( );
   The total download time may be determined by using the following command:
totalDownloadTime=timeEnd−timeStart;

Knowing (from the downloaded show configuration file) how long the current slide show image is to be displayed, Java engine 107 instructs main CPU 30 either to wait or to send the slide show image, downloaded in reference to steps 88-90, to display 20 (FIG. 7), step 84, using the following commands:

if(totalDownloadTime < slideDisplayTime) {
//calculate the time to wait
waitTime = slideDisplayTime − totalDownloadTime ;
//wait
wait(waitTime);
//display new slide
displayNewSlide( );
}
else{
//display new slide
displayNewSlide( );

Steps 84-96 are repeated until the last slide show image and sound clip are downloaded and processed in the manner generally illustrated in FIG. 4.

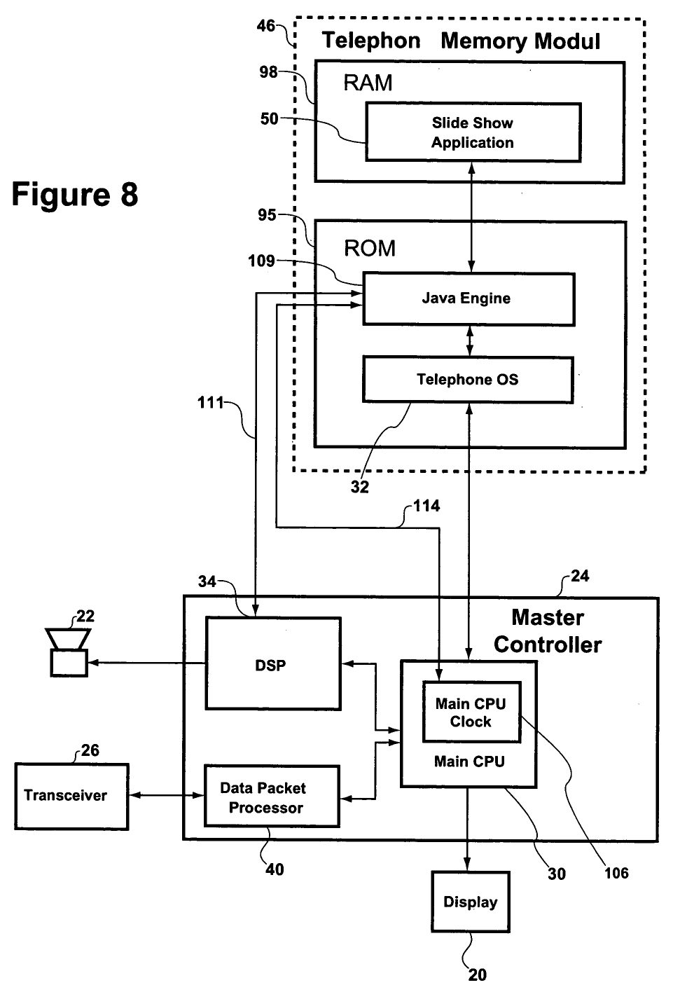

In still another embodiment of the present invention, high level application 48 may be implemented by means of a Java engine 109 adapted to run parallel to telephone OS 32, as generally depicted in FIG. 8. Java engine 109 runs slide show application 50 and is given access to low level DSP drivers 36 (FIG. 2) to allow Java engine 109 direct control of DSP 34 and its voice codecs 38 (FIG. 2), bypassing telephone OS 32, as generally shown by bi-directional arrow 111 of FIG. 8. Java engine 109 and telephone OS 32 reside in ROM 95 (FIG. 8) of TMM 46 (FIGS. 2, 8). Slide show application 50 resides in RAM 98 (FIG. 8) of TMM 46 (FIGS. 2, 8) and, as generally illustrated in FIG. 4, may be implemented using the following functional steps:
(1) The slide show program is executed on network-enabled mobile telephone 10 (FIG. 1), “start” step 76.
(2) Main CPU 30 downloads a show configuration file, step 78, on instructions from Java engine 109. The show configuration file contains information on how long each slide show image would be displayed, and on the duration of each associated slide show sound clip.
(3) Main CPU 30 downloads the first slide show image, step 80, on instructions from Java engine 109.
(4) Main CPU 30 downloads the first slide show sound clip, step 82, on instructions from Java engine 109.
(5) Main CPU 30 promptly sends the first downloaded slide show image to display 20 (FIG. 7), step 84, on instructions from Java engine 109. The displayed image is static.
(6) Upon appropriate instructions from Java engine 109, main CPU 30 hands over the first downloaded slide show sound clip to DSP 34, step 86, with DSP 34 outputting the same in analog form to speaker 22, as schematically depicted in FIG. 8. The user views the displayed static image while listening to the speaker output.
(7) As soon as main CPU 30 has handed over the first downloaded slide show sound clip to DSP 34, main CPU 30 downloads the next slide show image, step 88, on instructions from Java engine 109. Main CPU 30 is free to immediately download the next slide show image since audio processing of the first downloaded slide show sound clip has been transferred to DSP 34, thereby creating the appearance of multithreading. This “virtual” multithreading mode is made possible by Java engine 109 being able to directly control DSP 34 and its voice codecs 38 (FIG. 2), as generally shown by bi-directional arrow 111 of FIG. 8.
(8) Java engine 109 checks with main CPU 30 whether downloading of the slide show image (of step 88) is complete, step 90.
(9) If image downloading fails for any reason, such as due to network error or no more images being available for download, Java engine 109 terminates the slide show, “end” step 92.
(10) If image downloading is complete, main CPU 30 downloads the next slide show sound clip, step 94, on instructions from Java engine 109.
(11) Java engine 109 is preferably programmed to monitor main CPU clock 106, step 96, as generally shown by bi-directional arrow 114 of FIG. 8, to determine when to instruct main CPU 30 to send a successive downloaded slide show image, such as the slide show image downloaded in reference to steps 88-90 (FIG. 4), to display 20 (FIG. 8). The objective is to synchronize the sequential display of downloaded static slide show images with corresponding audio output of their associated downloaded slide show sound clips via speaker 22 (FIG. 8). One way to program Java engine 109 to monitor main CPU clock 106 may involve using a method such as currentTimeMillis, which returns the number of milliseconds that passed since midnight, Jan. 1, 1970. As the current static slide show image is displayed with the accompanying slide show sound clip being output via speaker 22 (FIG. 8), the time just before main CPU 30 starts downloading the next slide show image may be determined from main CPU clock 106 by using the following command:
timeStart=System.currentTimeMillis( )
   Next, the time right after main CPU 30 has completed downloading the next slide show sound clip may be determined from main CPU clock 106 by using the following command:
timeEnd=System.currentTimeMillis( )
   The total download time may be determined by using the following command:
totalDownloadTime=timeEnd−timeStart;

Knowing (from the downloaded show configuration file) how long the current slide show image is to be displayed, Java engine 109 instructs main CPU 30 either to wait or to send the slide show image, downloaded in reference to steps 88-90, to display 20 (FIG. 8), step 84, using the following commands:

if(totalDownloadTime < slideDisplayTime) {
//calculate the time to wait
waitTime = slideDisplayTime − totalDownloadTime ;
//wait
wait(waitTime);
//display new slide
displayNewSlide( );
}
else{
//display new slide
displayNewSlide( );

Steps 84-96 are repeated until the last slide show image and sound clip are downloaded and processed in the manner generally illustrated in FIG. 4.

High level application 48 may also be implemented under the Binary Runtime Environment for Wireless (BREW) open source online application development platform for wireless CDMA devices from Qualcomm. Using BREW, software developers can create portable high level applications, such as high level application 48, that will work on any CDMA device, such as mobile telephone 10. Native BREW applications are written in C or C++ programming languages. BREW also supports programming in other languages, such as Java™ and XML (extensible markup language). Other implementations are possible, provided such other implementations do not depart from the intended scope and spirit of the present invention.

A person skilled in the art would undoubtedly recognize that other components and/or configurations may be utilized in the above-described embodiments, provided that such other components and/or configurations do not depart from the intended purpose and scope of the present invention. Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

While the present invention has been described in detail with regards to the preferred embodiments, it should be appreciated that various modifications and variations may be made in the present invention without departing from the scope or spirit of the invention. In this regard it is important to note that practicing the invention is not limited to the applications described hereinabove. Many other applications and/or alterations may be utilized provided that such other applications and/or alterations do not depart from the intended purpose of the present invention. Also, features illustrated or described as part of one embodiment can be used in another embodiment to provide yet another embodiment such that the features are not limited to the specific embodiments described above. Thus, it is intended that the present invention cover all such embodiments and variations as long as such embodiments and variations come within the scope of the appended claims and their equivalents.

1. A mobile communication device comprising infrastructure capable of processing streamed multimedia data in a single threaded operating environment, said single threaded operating environment being adapted to process the streamed multimedia data in a virtual multithreaded mode using a slide show format.

2. The mobile communication device of claim 1, wherein said infrastructure comprises at least one central processing unit (CPU) being used to download images and associated sound clips, said downloaded images and associated sound clips being part of a multimedia data stream; at least one operating system (OS) operatively coupled to said at least one CPU, said at least one CPU being utilized to display said downloaded images; and at least one digital signal processor (DSP) operatively coupled to said at least one CPU and adapted for audio processing of said associated downloaded sound clips.

3. The mobile communication device of claim 2, wherein said infrastructure further comprises at least one high level application operatively coupled to said at least one CPU and being adapted to directly access said at least one DSP and run under the auspices of said at least one OS.

4. The mobile communication device of claim 3, wherein said at least one high level application is adapted to instruct said at least one CPU to display a first downloaded image in slide show format, hand over audio processing of its associated downloaded first sound clip to said at least one DSP, and immediately download a successive image and associated successive sound clip to create the appearance of processing said multimedia data stream in a multithreaded mode.

5. The mobile communication device of claim 4, wherein said at least one high level application is adapted to monitor said at least one DSP to determine if audio processing of said downloaded first sound clip is complete.

6. The mobile communication device of claim 4, wherein said at least one CPU includes a CPU clock.

7. The mobile communication device of claim 6, wherein said at least one high level application is adapted to monitor said CPU clock to determine when to instruct said at least one CPU to display said downloaded successive image.

8. The mobile communication device of claim 2, wherein said infrastructure further comprises at least one high level application operatively coupled to said at least one CPU and being adapted to directly access said at least one DSP and run parallel to said at least one OS.

9. The mobile communication device of claim 8, wherein said at least one high level application is adapted to instruct said at least one CPU to display a first downloaded image in slide show format, hand over audio processing of its associated downloaded first sound clip to said at least one DSP, and immediately download a successive image and associated successive sound clip to create the appearance of processing said multimedia data stream in a multithreaded mode.

10. The mobile communication device of claim 9, wherein said at least one high level application is adapted to monitor said at least one DSP to determine if audio processing of said downloaded first sound clip is complete.

11. The mobile communication device of claim 9, wherein said at least one CPU includes a CPU clock.

12. The mobile communication device of claim 11, wherein said at least one high level application is adapted to monitor said CPU clock to determine when to instruct said at least one CPU to display said downloaded successive image.

13. A method for processing streamed multimedia data, said method comprising the steps of:
(a) utilizing at least one central processing unit (CPU) to download an image and an associated sound clip, said downloaded image and sound clip being part of a multimedia data stream;
(b) utilizing said at least one CPU to display said downloaded image in a slide show format;
(c) handing over audio processing of said downloaded sound clip to at least one digital signal processor (DSP) to free up said at least one CPU to download a successive image and a successive associated sound clip;
(d) monitoring said at least one DSP to determine if audio processing of said downloaded sound clip is complete; and
(e) repeating steps (b)-(d), if audio processing of said downloaded sound clip is complete, to create the appearance of processing said multimedia data stream in a multithreaded mode.

14. A method for processing streamed multimedia data, said method comprising the steps of:
(a) utilizing at least one central processing unit (CPU) to download an image and an associated sound clip, said downloaded image and sound clip being part of a multimedia data stream;
(b) utilizing said at least one CPU to display said downloaded image in a slide show format, said at least one CPU having a CPU clock;
(c) handing over audio processing of said downloaded sound clip to at least one digital signal processor (DSP) to free up said at least one CPU to download a successive image and a successive associated sound clip;
(d) monitoring said CPU clock to determine when to instruct said at least one CPU to display said downloaded successive image; and
(e) repeating steps (b)-(d) to create the appearance of processing said multimedia data stream in a multithreaded mode.

15. The method of claim 13, further comprising the step of terminating the processing of said multimedia data stream if said at least one CPU fails to download at least one successive image.

16. The method of claim 14, further comprising the step of terminating the processing of said multimedia data stream if said at least one CPU fails to download at least one successive image.

17. An apparatus for processing streamed multimedia data, comprising:
(a) at least one central processing unit (CPU) being used to download images and associated sound clips, said downloaded images and associated sound clips being part of a multimedia data stream, said at least one CPU being utilized to display said downloaded images;
(b) at least one operating system (OS) operatively coupled to said at least one CPU;
(c) at least one digital signal processor (DSP) operatively coupled to said at least one CPU and adapted for audio processing of said associated downloaded sound clips; and
(d) at least one high level application operatively coupled to said at least one CPU and adapted to directly access said at least one DSP and run under the auspices of said at least one OS, said at least one high level application being adapted to instruct said at least one CPU to display a first downloaded image in a slide show format, hand over audio processing of a first associated downloaded sound clip to said at least one DSP, immediately download a successive image and associated successive sound clip, monitor said at least one DSP to determine if audio processing of said first downloaded sound clip is complete, and display said downloaded successive image, if audio processing of said first downloaded sound clip is complete, to create the appearance of processing said multimedia data stream in a multithreaded mode.

18. The apparatus of claim 17, wherein said at least one high level application is adapted to terminate processing of said multimedia data stream if said at least one CPU fails to download at least one successive image.

19. An apparatus for processing streamed multimedia data, comprising:
(a) at least one central processing unit (CPU) being used to download images and associated sound clips, said downloaded images and associated sound clips being part of a multimedia data stream, said at least one CPU being utilized to display said downloaded images;
(b) at least one operating system (OS) operatively coupled to said at least one CPU;
(c) at least one digital signal processor (DSP) operatively coupled to said at least one CPU and adapted for audio processing of said associated downloaded sound clips; and
(d) at least one high level application operatively coupled to said at least one CPU and adapted to directly access said at least one DSP and run parallel to said at least one OS, said at least one high level application being adapted to instruct said at least one CPU to display a first downloaded image in a slide show format, hand over audio processing of a first associated downloaded sound clip to said at least one DSP, immediately download a successive image and associated successive sound clip, monitor said at least one DSP to determine if audio processing of said first downloaded sound clip is complete, and display said downloaded successive image, if audio processing of said first downloaded sound clip is complete, to create the appearance of processing said multimedia data stream in a multithreaded mode.

20. The apparatus of claim 19, wherein said at least one high level application is adapted to terminate processing of said multimedia data stream if said at least one CPU fails to download at least one successive image.

21. An apparatus for processing streamed multimedia data, comprising:
(a) at least one central processing unit (CPU) being used to download images and associated sound clips, said downloaded images and associated sound clips being part of a multimedia data stream, said at least one CPU being utilized to display said downloaded images;
(b) at least one operating system (OS) operatively coupled to said at least one CPU, said at least one CPU having a CPU clock;
(c) at least one digital signal processor (DSP) operatively coupled to said at least one CPU and adapted for audio processing of said associated downloaded sound clips; and
(d) at least one high level application operatively coupled to said at least one CPU and adapted to directly access said at least one DSP and run under the auspices of said at least one OS, said at least one high level application being adapted to instruct said at least one CPU to display a first downloaded image in a slide show format, hand over audio processing of a first associated downloaded sound clip to said at least one DSP, immediately download a successive image and associated successive sound clip, monitor said CPU clock to determine when to instruct said at least one CPU to display said downloaded successive image, and display said downloaded successive image to create the appearance of processing said multimedia data stream in a multithreaded mode.

22. The apparatus of claim 21, wherein said at least one high level application is adapted to terminate processing of said multimedia data stream if said at least one CPU fails to download at least one successive image.

23. An apparatus for processing streamed multimedia data, comprising:
(a) at least one central processing unit (CPU) being used to download images and associated sound clips, said downloaded images and associated sound clips being part of a multimedia data stream, said at least one CPU being utilized to display said downloaded images;
(b) at least one operating system (OS) operatively coupled to said at least one CPU, said at least one CPU having a CPU clock;
(c) at least one digital signal processor (DSP) operatively coupled to said at least one CPU and adapted for audio processing of said associated downloaded sound clips; and
(d) at least one high level application operatively coupled to said at least one CPU and adapted to directly access said at least one DSP and run parallel to said at least one OS, said at least one high level application being adapted to instruct said at least one CPU to display a first downloaded image in a slide show format, hand over audio processing of a first associated downloaded sound clip to said at least one DSP, immediately download a successive image and associated successive sound clip, monitor said CPU clock to determine when to instruct said at least one CPU to display said downloaded successive image, and display said downloaded successive image to create the appearance of processing said multimedia data stream in a multithreaded mode.

24. The apparatus of claim 23, wherein said at least one high level application is adapted to terminate processing of said multimedia data stream if said at least one CPU fails to download at least one successive image.

25. A system for processing streamed multimedia data comprising at least one high level application operatively coupled between at least one central processing unit (CPU) and at least one digital signal processor (DSP) and adapted to run under the auspices of at least one operating system (OS), said at least one high level application being adapted to instruct said at least one CPU, by way of said at least one OS, to display a downloaded image, hand over audio processing of an associated downloaded sound clip to said at least one DSP, and immediately download a successive image and associated successive sound clip to create the appearance of processing the streamed multimedia data in a multithreaded mode.

26. A system for processing streamed multimedia data comprising at least one high level application operatively coupled between at least one central processing unit (CPU) and at least one digital signal processor (DSP) and adapted to run parallel to at least one operating system (OS), said at least one high level application being adapted to instruct said at least one CPU, bypassing said at least one OS, to display a downloaded image, hand over audio processing of an associated downloaded sound clip to said at least one DSP, and immediately download a successive image and associated successive sound clip to create the appearance of processing the streamed multimedia data in a multithreaded mode.
